(19) United States
(12) Patent Application Publication
(10) Pub. No.: US 2006/0125719 A1
(43) Pub. Date: Jun. 15, 2006

(54) Plasma display apparatus and driving method thereof

(75) Inventors: Sunggon Shin, Hapcheon-gun (KR); Yunkwon Jung, Gumi-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/286,350

(22) Filed: Nov. 25, 2005

(30) Foreign Application Priority Data
Dec. 10, 2004 (KR) 10-2004-0104493

(51) Int. Cl. G09G 3/28

(52) U.S. Cl. 345/60

(57) ABSTRACT

The present invention relates to a plasma display apparatus and driving method thereof. A plasma display apparatus according to the present invention comprises a plasma display panel comprising scan electrodes and sustain electrodes, a driver that applies a plurality of sustain pulses to the scan electrodes or the sustain electrodes, and a timing controller that controls a time lag from at least one of the plurality of sustain pulses to a next sustain pulse to be different from a time lag from the remaining sustain pulses to a next sustain pulse.

### BACKGROUND OF THE INVENTION

### CROSS-REFERENCES TO RELATED APPLICATIONS

This Nonprovisional application claims priority under 35 U.S.C. § 119(a) on Patent Application No. 10-2004-0104493 filed in Korea on Dec. 10, 2004, the entire contents of which are hereby incorporated by reference.

1. Field of the Invention

The present invention relates to a plasma display apparatus and driving method thereof.

2. Background of the Related Art

In general, a plasma display apparatus comprises a plasma display panel having a front substrate and a rear substrate. A barrier rib formed between the front substrate and the rear substrate forms one unit cell. Each cell is filled with a primary discharge gas, such as neon (Ne), helium (He) or a mixed gas of Ne+He, and an inert gas containing a small amount of xenon (Xe). If the inert gas is discharged with a high frequency voltage, vacuum ultraviolet rays are generated. Phosphors formed between the barrier ribs are excited to implement images. The plasma display panel can be made thin, and has thus been in the spotlight as the next-generation display devices.

FIG. 1 shows the construction of a general plasma display panel.

As shown in FIG. 1, the plasma display panel comprises a front substrate 100 and a rear substrate 110. In the front substrate 100, a plurality of sustain electrode pairs in which scan electrodes 102 and sustain electrodes 103 are formed in pairs is arranged on a front glass 101 serving as a display surface on which images are displayed. In the rear substrate 110, a plurality of address electrodes 113 crossing the plurality of sustain electrode pairs is arranged on a rear glass 111 serving as a rear surface. At this time, the front substrate 100 and the rear substrate 110 are parallel to each other with a predetermined distance therebetween.

The front substrate 100 comprises the pairs of scan electrodes 102 and sustain electrodes 103, which mutually discharge one another and maintain the emission of a cell within one discharge cell. In other words, each of the scan electrode 102 and the sustain electrode 103 has a transparent electrode “a” formed of a transparent ITO material and a bus electrode “b” formed of a metal material. The scan electrodes 102 and the sustain electrodes 103 are covered with one or more dielectric layers 104 for limiting a discharge current and providing insulation among the electrode pairs. A protection layer 105 having Magnesium Oxide (MgO) deposited thereon is formed on the dielectric layers 104 so as to facilitate discharge conditions.

In the rear substrate 110, barrier ribs 112 of stripe form (or well form), for forming a plurality of discharge spaces, i.e., discharge cells are arranged parallel to one another. Furthermore, a plurality of address electrodes 113, which generate vacuum ultraviolet rays by performing an address discharge, are disposed parallel to the barrier ribs 112. R, G and B phosphor layers 114 that radiate a visible ray for displaying images during an address discharge are coated on a top surface of the rear substrate 110. A dielectric layer 115 for protecting the address electrodes 113 is formed between the address electrodes 113 and the phosphor layers 114.

A driving waveform depending on a driving method of the plasma display panel in the related art will be described with reference to FIG. 2.

FIG. 2 shows a driving waveform depending on a driving method of the plasma display panel in the related art.

As shown in FIG. 2, the plasma display panel is driven with it being divided into a reset period for initializing the entire cells, an address period for selecting cells to be discharged, a sustain period for sustaining the discharge of selected cells and an erase period for erasing wall charges within discharged cells.

In a set-up period of the reset period, a ramp-up waveform (Ramp-up) is applied to the entire scan electrodes at the same time. The ramp-up waveform generates a weak dark discharge within the discharge cells of the entire screen. The ramp-up discharge also causes positive wall charges to be accumulated on the address electrodes and the sustain electrodes, and negative wall charges to be accumulated on the scan electrodes.

In a set-down period of the reset period, after the ramp-up waveform is applied, a ramp-down waveform (Ramp-down), which begins falling from a positive voltage lower than a peak voltage of the ramp-up waveform to a predetermined voltage level lower than a ground (GND) level voltage, generates a weak erase discharge within the cells, thus sufficiently erasing wall charges excessively formed on the scan electrodes. The set-down discharge causes wall charges of the degree in which an address discharge can be stably generated to uniformly remain within the cells.

In the address period, while negative scan pulses are sequentially applied to the scan electrodes, a positive data pulse is applied to the address electrodes in synchronization with the scan waveform. As a voltage difference between the scan pulse and the data pulse and a wall voltage generated in the reset period are added, an address discharge is generated within the discharge cells to which the data pulse is applied.

Furthermore, wall charges of the degree in which a discharge can be generated when a sustain voltage (Vs) is applied are formed within cells selected by the address discharge. During the set-down period and the address period, the sustain electrode is supplied with a positive voltage (Vz) such that an erroneous discharge is not generated between the sustain electrode and the scan electrodes by reducing a voltage difference between the sustain electrode and the scan electrodes.

In the sustain period, sustain pulse (sus) are alternately applied to the scan electrode and the sustain electrode. As a wall voltage within the cells and the sustain pulse are added, a sustain discharge, i.e., a display discharge is generated between the scan electrode and the sustain electrode in the cells selected by the address discharge whenever the sustain pulse is applied.

After the sustain discharge is completed, in the erase period, a voltage of an erase ramp waveform (Ramp-ers) having a narrow pulse width and a low voltage level is applied to the sustain electrodes, thereby erasing wall charges remaining within the cells of the entire screen.

In this driving waveform, the sustain pulse applied in the sustain period will be described in more detail with reference to FIG. 3.

FIG. 3 is a view showing, in detail, the sustain pulse applied in the sustain period when the plasma display panel is driven.

As shown in FIG. 3, if the sustain voltage (Vs) is applied to the scan electrode Y with a voltage of a ground level (GND) being applied to the sustain electrode Z, a sustain discharge by the scan electrode Y is generated. To the contrary, if the sustain voltage (Vs) is applied to the sustain electrode Z with the voltage of the ground level (GND) being applied to the scan electrode Y, a sustain discharge by the sustain electrode Z is generated. As described above, the sustain discharge is alternately generated by the scan electrode Y and the sustain electrode Z. Furthermore, in the sustain pulses of the related art, a time lag in a discharge time point between the sustain discharges, which are alternately generated by the scan electrode Y and the sustain electrode Z, is the same.

Such a sustain discharge causes the phosphor layers within the discharge cells to emit relatively strong light according to a main display discharge of the plasma display panel.

Meanwhile, the phosphor layers (114 in FIG. 1) within the aforementioned discharge cells do not generate much light as the number of the sustain pulses is increased, but have a luminance saturation characteristic at which light is saturated at a predetermined point. The luminance saturation characteristic of the phosphor layers will be described with reference to FIG. 4.

FIG. 4 is a view for illustrating luminance saturation characteristics of phosphors of a general plasma display panel.

As shown in FIG. 4, phosphors of a general plasma display panel do not generate a greater amount of light as the number of sustain pulses increases, but are saturated at a predetermined point (a). For example, assuming that the number of sustain pulses is 300 when the phosphors reach a luminance saturation point, the phosphors generate the amount of light as much as luminance at the point where the number of the sustain pulses is 300 although the number of the sustain pulses exceeds 500. Luminance saturation of the phosphors occurs when the sustain pulses are consecutively applied.

The reason why the luminance saturation characteristic of the phosphors is generated will now be described. Predetermined phosphors exist initially in a stable state within the discharge cells and then have its state changed to an unstable state after a sustain discharge is generated, emitting predetermined light. Thereafter, after a predetermined time elapses, the phosphors return to a stable state.

That is, if a sustain discharge is generated, the phosphors becomes an unstable state, and return to a stable state after a predetermined time elapses. If a sustain pulse, i.e., a sustain discharge is consecutively generated in the phosphors with this characteristic, the sustain discharge causes the phosphors to become unstable before they return to a stable state. If this process continues, the phosphors continue to keep unstable and thus saturated.

As a result, although the umber of sustain pulses is increased, the amount of light generated is not increased due to a phosphor saturation characteristic. Therefore, problems arise because luminance of a plasma display panel is lowered and driving efficiency is degraded.

### SUMMARY OF THE INVENTION

Accordingly, the present invention has been made in view of the above problems occurring in the prior art, and it is an object of the present invention to provide a plasma display apparatus and driving method thereof, in which driving efficiency can be improved by prohibiting phosphors from reaching a luminance saturation point although the number of sustain pulses in a sustain period increases when a plasma display panel is driven.

To achieve the above object, a plasma display apparatus according to an aspect of the present invention comprises a plasma display panel comprising scan electrodes and sustain electrodes, a driver that applies a plurality of sustain pulses to the scan electrodes or the sustain electrodes, and a timing controller that controls a time lag from at least one of the plurality of sustain pulses to a next sustain pulse to be different from a time lag from the remaining sustain pulses to a next sustain pulse.

The timing controller may control a time lag from at least one of the plurality of sustain pulses to a next sustain pulse to be longer than a time lag from the remaining sustain pulses to a next sustain pulse.

A time lag from at least one of the plurality of sustain pulses to a next sustain pulse may be set in the range of 10 μs to 500 μs.

A time lag from at least one of the plurality of sustain pulses to a next sustain pulse may be controlled according to a luminance saturation characteristic of phosphors.

A time lag from at least one of the plurality of sustain pulses to a next sustain pulse may be set to increase as the luminance saturation characteristic of the phosphors becomes profound.

A plasma display apparatus that displays images through a combination of a plurality of sub-fields according to another aspect of the present invention comprises a plasma display panel in which a plurality of sustain pulses is applied in a sustain period of the sub-fields, and a timing controller that controls the plurality of sustain pulses to be divided into a plurality of sustain pulse groups, and controls a time lag between the sustain pulse groups to be different from that between sustain pulses within the sustain pulse groups, in at least one of the plurality of sub-fields.

The timing controller may control the time lag between the sustain pulse groups to be longer than that between the sustain pulses within the sustain pulse groups.

The time lag between the sustain pulses within the sustain pulse groups may be set to be the same.

The time lag between the sustain pulse groups may be set to range from 10 μs to 500 μs.

The number of the sustain pulse groups may be 2.

The time lag between the sustain pulse groups may be controlled according to a luminance saturation characteristic of phosphors.

The time lag between the sustain pulse groups may be set to increase as the luminance saturation characteristic of the phosphors becomes profound.

The number of the sustain pulses within each of the plurality of sustain pulse groups may be the same.

In a driving method of a plasma display apparatus that displays images through a combination of a plurality of sub-fields according to further another aspect of the present invention, a plurality of sustain pulses applied in a sustain period of the sub-fields is divided into a plurality of sustain pulse groups, and a time lag between the sustain pulse groups is set to be different from that between sustain pulses within the sustain pulse groups in at least one of the plurality of sub-fields.

The present invention is advantageous in that it can enhance driving efficiency by improving sustain pulses applied in a sustain period.

### BRIEF DESCRIPTION OF THE DRAWINGS

Further objects and advantages of the invention can be more fully understood from the following detailed description taken in conjunction with the accompanying drawings in which:

FIG. 1 shows the construction of a general plasma display panel;

FIG. 2 shows a driving waveform depending on a driving method of the plasma display panel in the related art;

FIG. 3 is a view showing, in detail, a sustain pulse applied in a sustain period when the plasma display panel is driven;

FIG. 4 is a view for illustrating luminance saturation characteristics of phosphors of a general plasma display panel;

FIG. 5 is a block diagram schematically showing the construction of a plasma display apparatus according to the present invention;

FISG. 6a to 6d are views for illustrating a driving method of a plasma display apparatus according to a first embodiment of the present invention;

FIG. 7 is a graph showing a luminance characteristic curve according to the driving method of the plasma display apparatus of the present invention;

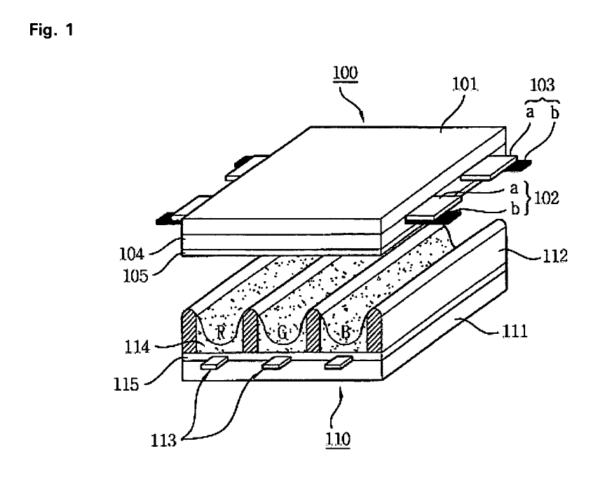

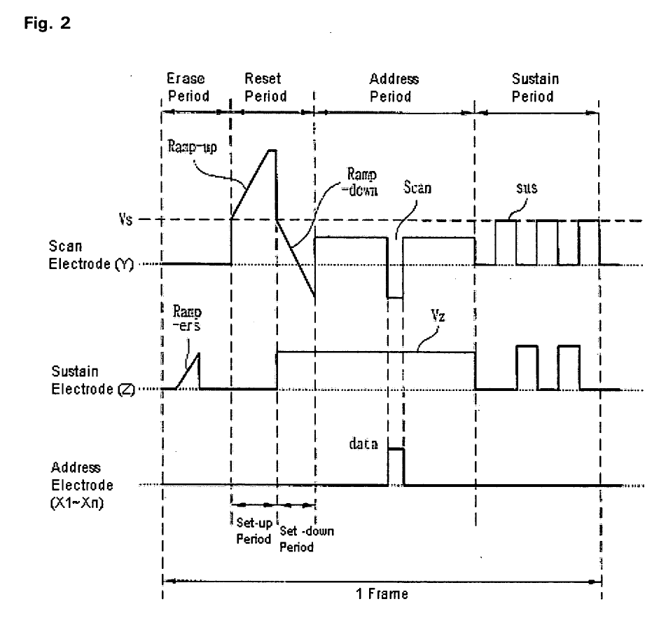

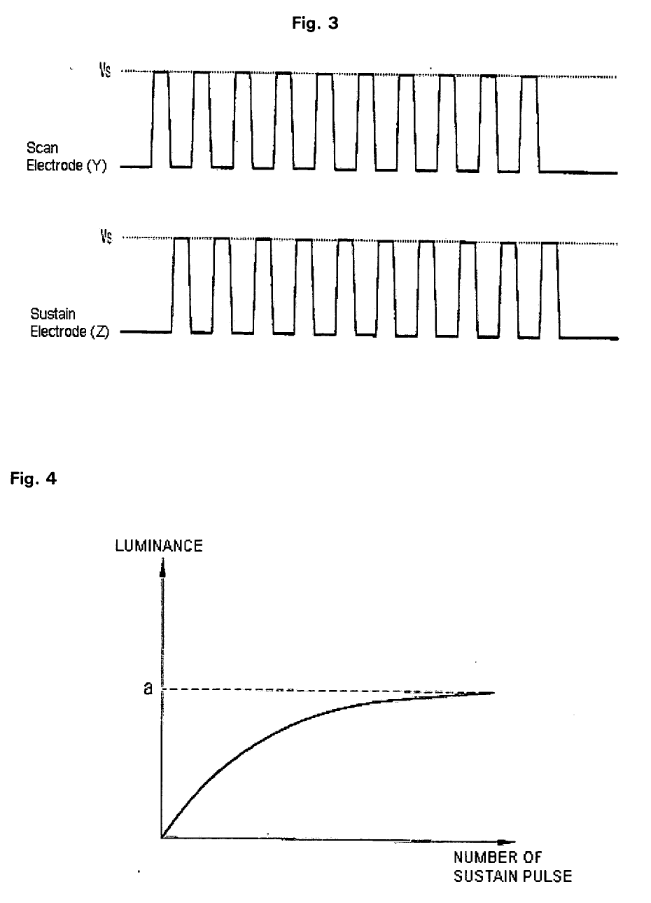

FISG. 8a to 8d are views for illustrating a driving method of a plasma display apparatus according to a second embodiment of the present invention; and

FISG. 9a and 9b are views for illustrating a driving method of a plasma display apparatus according to a third embodiment of the present invention.

### DETAILED DESCRIPTION OF THE PREFERRED EMBODIMENT

A plasma display apparatus and driving method thereof according to the present invention will now be described in detail in connection with preferred embodiments with reference to the accompanying drawings.

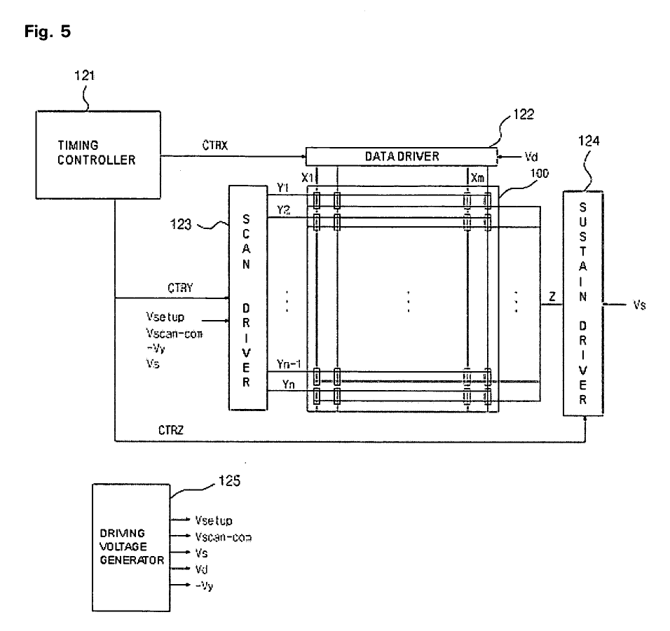

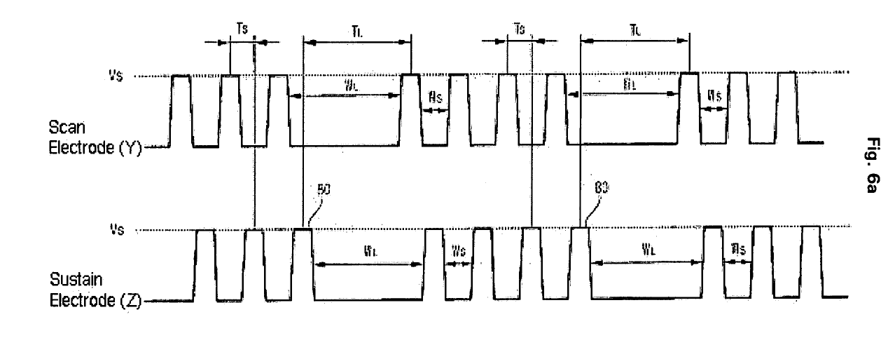

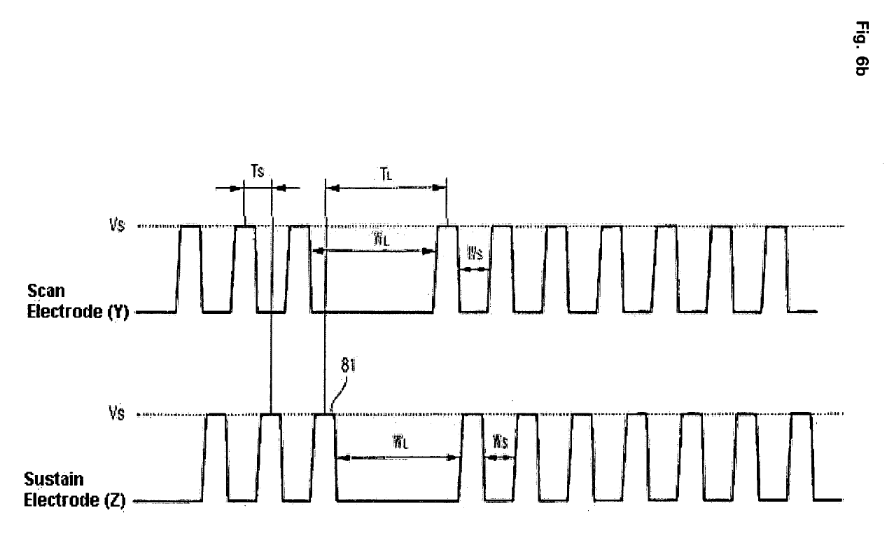

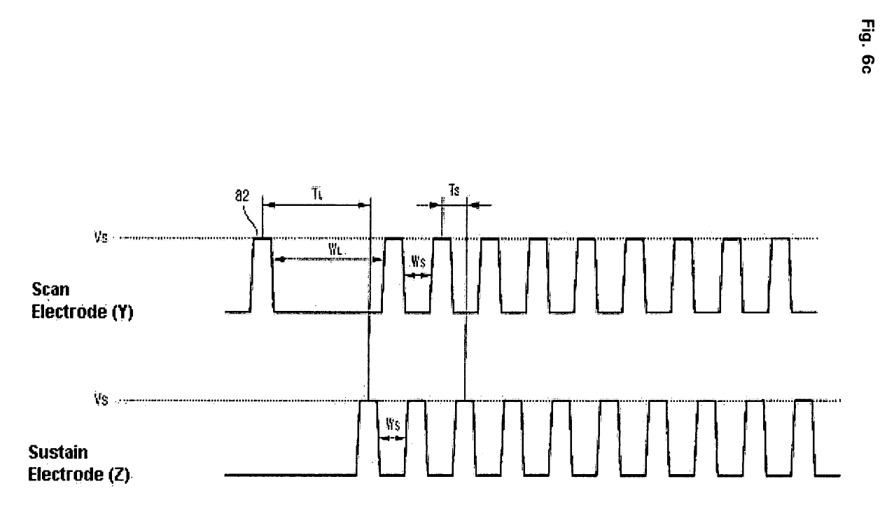

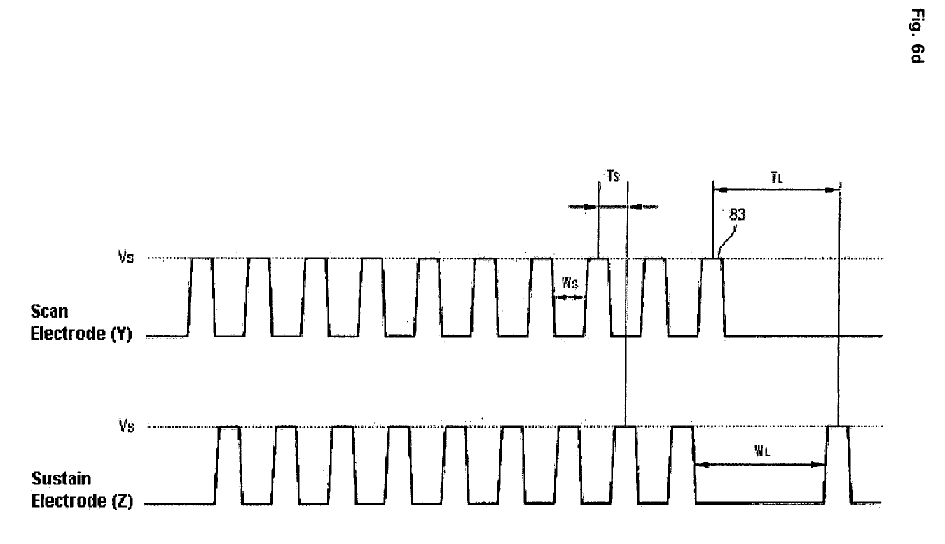

FIG. 5 is a block diagram schematically showing the construction of a plasma display apparatus according to the present invention.

As shown in FIG. 5, the plasma display apparatus according to the present invention comprises a plasma display panel 100, a data driver 122 for supplying data to address electrodes X1 to Xm formed in a lower substrate (not shown) of the plasma display panel 100, a scan driver 123 for driving scan electrodes Y1 to Yn, a sustain driver 124 for driving sustain electrodes Z, i.e., a common electrode, a timing controller 121 for controlling the data driver 122, the scan driver 123 and the sustain driver 124 when the plasma display panel operates, and a driving voltage generator 125 for supplying driving voltages necessary for the drivers 122, 123 and 124.

The plasma display apparatus constructed above according to the present invention is driven with one frame being divided into a plurality of sub-fields, each of the sub-fields being divided into a reset period, an address period and a sustain period, and a driving signal being applied to each of the electrodes formed in the plasma display panel in each of the periods.

The plasma display panel 100 comprises an upper substrate (not shown) and a lower substrate (not shown), which are adhered with a predetermined distance therebetween. A plurality of electrodes, such as the scan electrodes Y1 to Yn and the sustain electrodes Z, is formed in pairs in the upper substrate. The address electrodes X1 to Xm are formed to cross the scan electrodes Y1 to Yn and the sustain electrodes Z in the lower substrate.

The data driver 122 is supplied with data, which have experienced inverse gamma correction, error diffusion, etc. through an inverse gamma correction circuit (not shown), an error diffusion circuit (not shown) and the like and are then mapped to respective sub-fields by a sub-field mapping circuit. The data driver 122 samples and latches data in response to a timing control signal (CTRX) from the timing controller 121 and supplies the data to the address electrodes X1 to Xm.

The scan driver 123 supplies a ramp-up waveform (Ramp-up) and a ramp-down waveform (Ramp-down) to the scan electrodes Y1 to Yn under the control of the timing controller 121 during the reset period. The scan driver 123 also sequentially supplies scan pulses of a scan voltage to the scan electrodes Y1 to Yn under the control of the timing controller 121 during the address period. The scan driver 123 comprises an energy recovery circuit (not shown) and supplies a sustain pulse, which rises up to a sustain voltage, to the scan electrodes under the control of the timing controller 121 during the sustain period.

The sustain driver 124 also comprises an energy recovery circuit (not shown) in the same manner as the scan driver 123, and it supplies a sustain pulse (sus) to the sustain electrodes Z under the control of the timing controller 121 during the sustain period. The energy recovery circuit comprised in the sustain driver 124 has the same construction as that comprised in the scan driver 123, and it alternately operates with the energy recovery circuit comprised in the scan driver 123.

The timing controller 121 receives vertical/horizontal sync signals and a clock signal, generates timing control signals (CTRX, CTRY and CTRZ) for controlling an operating timing and synchronization of the respective drivers 122, 123 and 124 in the reset period, the address period and the sustain period, and provides the generated timing control signals (CTRX, CTRY and CTRZ) to corresponding drivers 122, 123 and 124, thus controlling the respective drivers 122, 123 and 124.

More particularly, the timing controller 121 controls a time lag between the sustain pulses, which are supplied to the scan electrodes or the sustain electrodes by the scan driver 123 or the sustain driver 124 in the sustain period, according to a phosphor luminance saturation characteristic. Furthermore, the timing controller 121 controls a time lag between sustain pulse groups or a time lag between sustain pulses within the sustain pulse groups a phosphor luminance saturation characteristic even when a plurality of sustain pulses is supplied to the scan electrodes or the sustain electrodes with them being divided into a plurality of sustain pulse groups. This will be described in more detail later in the driving method of the plasma display apparatus according to the present invention.

Meanwhile, the data control signal (CTRX) comprises a sampling clock for sampling data, a latch control signal, and a switching control signal for controlling an on/off time of a driving switch element. The scan control signal (CTRY) comprises a switching control signal for controlling an on/off time of an energy recovery circuit and a driving switch element within the scan driver 123. The sustain control signal (CTRZ) comprises a switching control signal for controlling an on/off time of an energy recovery circuit and a driving switch element within the sustain driver 124.

The driving voltage generator 125 generates a set-up voltage (Vsetup), a common scan voltage (Vscan-com), a scan voltage (−Vy), a sustain voltage (Vs), a data voltage (Vd) and the like. These driving voltages may be varied depending upon the composition of a discharge or the structure of a discharge cell.

FISG. 6a to 6d are views for illustrating a driving method of a plasma display apparatus according to a first embodiment of the present invention.

As shown in the drawings, in the driving method of the plasma display apparatus according to the first embodiment of the present invention, a plurality of sustain pulses is alternately supplied to the scan electrodes Y and the sustain electrodes Z in the sustain period, generating a sustain discharge. A time lag until a next sustain pulse is applied since at least one of the plurality of sustain pulse is different from that until a next sustain pulse is applied since the remaining sustain pulses. In this case, the time lag until the next sustain pulse is applied since at least one of the plurality of sustain pulse can be greater than that until the next sustain pulse is applied since the remaining sustain pulses.

For example, as shown in FIG. 6a, assuming that two of sustain pulses 80 applied to the sustain electrodes in the sustain period of one sub-field is selected, a difference between application times of the selected sustain pulses is W_{L} and a distance between other pulses is Ws, W_{L} is set to be greater than Ws. The distance between the pulses is set to be the same even in the scan electrodes.

If sustain pulses having both W_{L} and Ws are alternately applied to the scan electrodes and the sustain electrodes as shown in FIG. 6a, a time lag distance between the sustain pulses applied to the scan electrodes and the sustain electrodes can be expressed in Ts and T_{L}. A time lag (T_{L}) between the selected pulses is set to be greater than a time lag (Ts) between other pulses.

The time lag (T_{L}) between the aforementioned described sustain pulses can be set within a range of 10 μs to 500 μs. The reason can be described as follows. Since the length of a sustain period of one sub-field could not be long infinitely, a time of 500 μs at most is set as the time lag (T_{L}) between the sustain pulses in order to secure sustain margin. Furthermore, only when the time lag (T_{L}) between the sustain pulses is set to a time of 10 μs or higher, luminance can be prevented from being degraded due to a luminance saturation characteristic of phosphors and driving efficiency can be improved accordingly.

Referring to FIG. 6b, unlike FIG. 6a, the above-described time lag (T_{L}) between the sustain pulses is comprised only once within the sustain pulse. That is, a sustain discharge in which a time lag between discharge time points until a next sustain discharge is generated since a sustain discharge is in the range of 10 μs to 500 μs, of a plurality of sustain discharges generated by a plurality of sustain pulses, can be 1 or less in a sustain period of one sub-field.

As described above, the time lag between the sustain pulse, which is relatively longer than that between the remaining sustain pulses is generated in a predetermined one of the sustain pulses applied in the sustain period. For example, as shown in FIG. 6c, a difference (T_{L}) between discharge time points can be inserted after a first sustain pulse applied to the scan electrodes Y in a sustain period. As shown in FIG. 6d, a difference (T_{L}) between discharge time points can be inserted after a last sustain pulse applied to the scan electrodes Y in a sustain period.

The time lag (T_{L}) between these discharge time points is controlled according to a luminance saturation characteristic of phosphors. For instance, the time lag (T_{L}) between the discharge time points can be increased within the range of 10 μs to 500 μs as the luminance saturation characteristic of the phosphors becomes profound.

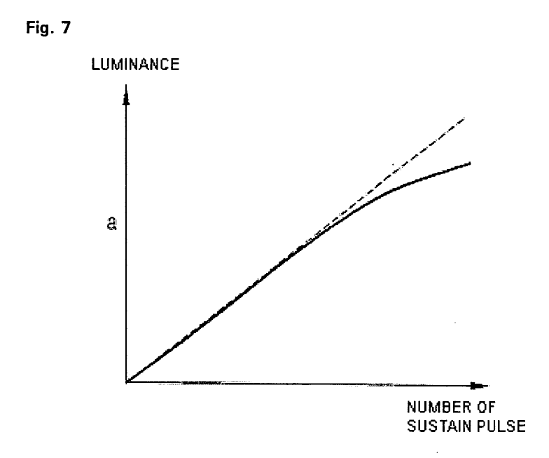

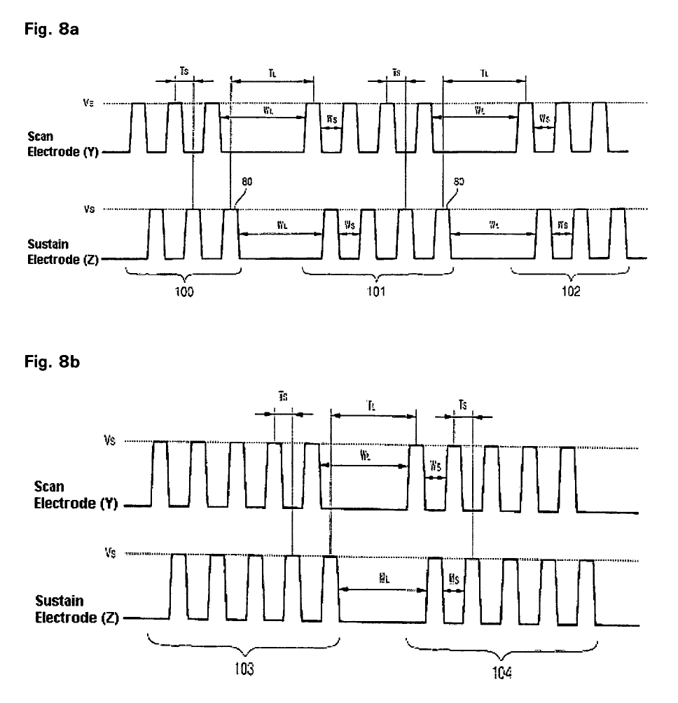

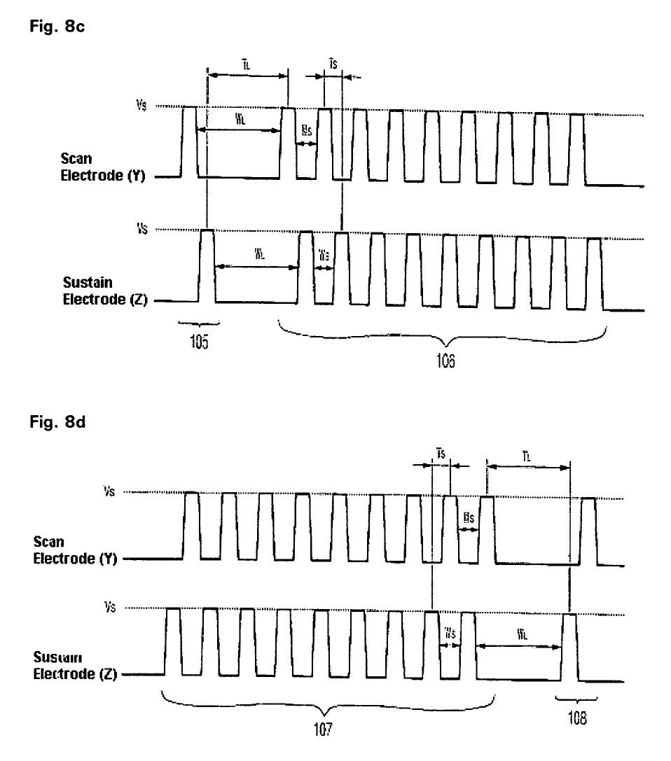

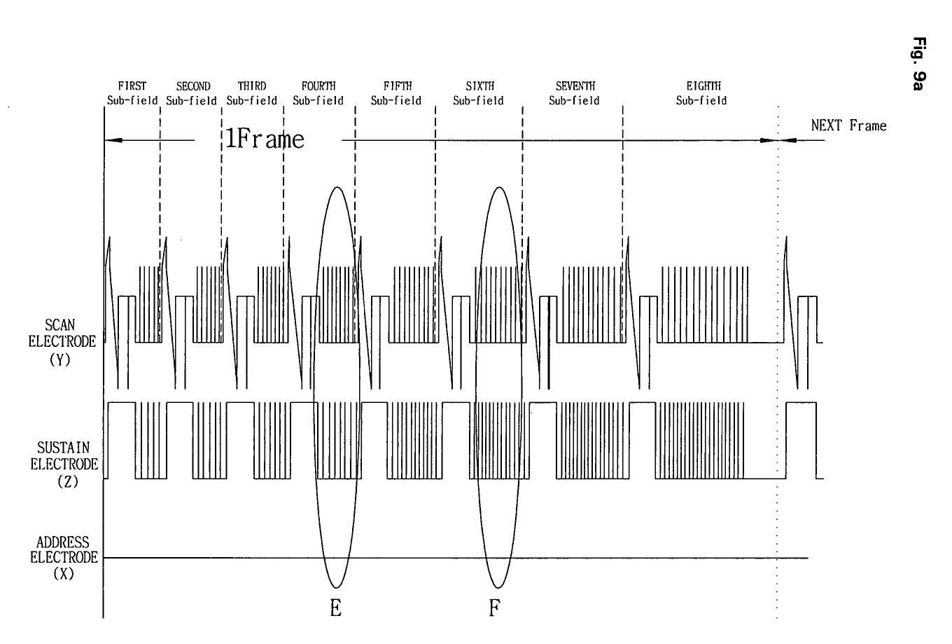

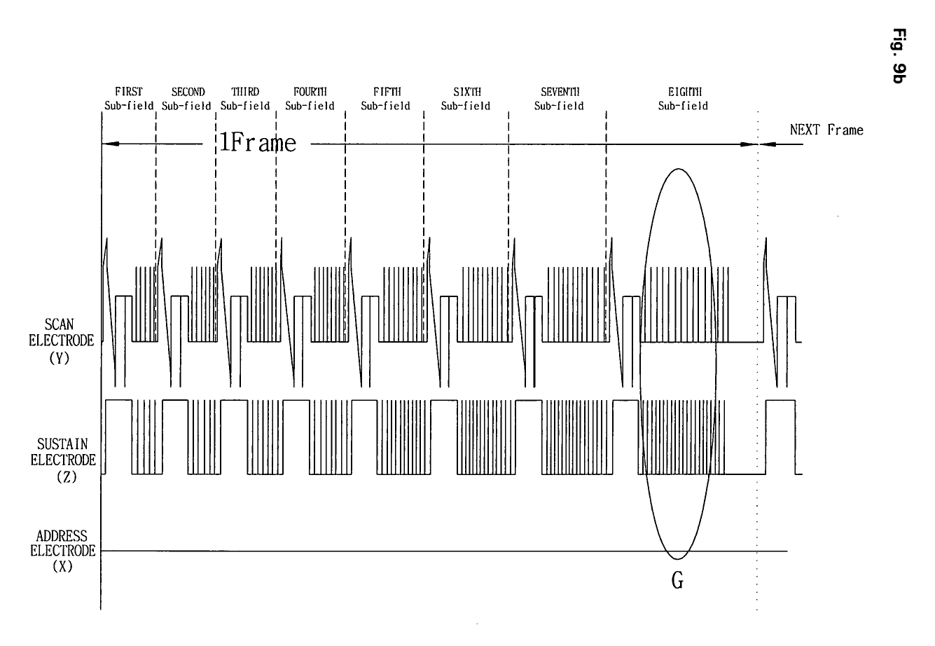

By setting a time lag between discharge time points until a next sustain discharge is generated after at least one sustain discharge in one sustain period to be greater than those until a next sustain discharge is generated after the remaining sustain discharges, i.e., by inserting the time lag (T_{L}) between the discharge time points between the sustain pulses applied to the scan electrodes or the sustain electrodes in the sustain period, driving efficiency of the plasma display panel can be prevented from lowering because of a luminance saturation characteristic of phosphors. This characteristic curve will be described with reference to FIG. 7.

FIG. 7 is a graph showing a luminance characteristic curve according to the driving method of the plasma display apparatus of the present invention.

As shown in FIG. 7, the degree in which phosphors are saturated by the driving waveform of the present invention is lower than those by FIG. 4 in the related art. That is, in the driving waveform of the present invention, the phosphors are not saturated in comparison with FIG. 4 in the related art, or the phosphors are saturated at a higher luminance in comparison with FIG. 4 in the related art although the phosphors are saturated.

As a result, the driving waveform of the present invention can generate a greater amount of light compared with the related art. Therefore, since the amount of light, which is generated compared with the same number of sustain discharges, i.e., sustain pulses, is increased, driving efficiency can be improved.

For example, assuming that in the driving waveform of the related art, phosphors are saturated at a point where the number of sustain discharges, i.e., sustain pulse is 300, corresponding phosphors generate the amount of light, which is equivalent to luminance at a point where the number of sustain discharges is 300 although sustain discharges of 500 in number are applied in the related art. In the driving waveform of the present invention, however, since the phosphors are not saturated, the amount of light, which is equivalent to sustain discharges of 500 in number, is generated, or although the phosphors are saturated, the amount of light generated is increased after the phosphors are saturated at a point of the number of sustain discharges, which is larger than 300 in the related art.

As described above, the reason why a greater amount of light is generated in comparison with the related art in the case where the same number of sustain discharges as those of the related art is generated, is that because a state where a discharge is not generated is kept for a relatively long time while sustain discharges are consecutively generate, a sufficient time of the degree in which the phosphors whose state is unstable can be stabilized is secured. Therefore, since the phosphors generate light after being stabilized, a total amount of light generated in one sustain period is increased. As a result, even if the number of sustain pulses increases, a decrease in the luminance of the plasma display panel, which is incurred by a luminance saturation characteristic of the phosphors, can be prohibited and driving efficiency can be enhanced accordingly.

In the first embodiment of the present invention, a time lag between discharge time points until a next sustain discharge is generated after at least one sustain discharge in a sustain period is set to be greater than those until a next sustain discharge is generated after the remaining sustain discharges. Unlike the above, sustain discharges generated in the sustain period can be divided into predetermined groups, and a difference between the discharge time points can be controlled on a group basis.

FISG. 8a to 8d are views for illustrating a driving method of a plasma display apparatus according to a second embodiment of the present invention.

As shown in FIG. 8a to 8d, in the driving method of the plasma display apparatus according to the second embodiment of the present invention, a plurality of sustain pulses applied to the scan electrodes Y or the sustain electrodes Z in the sustain period is divided into a plurality of sustain pulse groups. A time lag between at least one sustain pulse group, of time lags between the plurality of sustain pulse groups, is set to be different from a time lag between the remaining sustain pulse groups.

The time lag between the plurality of sustain pulse groups ca be set to be greater than a time lag between sustain pulses within the sustain pulse groups.

For example, as shown in FIG. 8a, sustain pulses comprised in a sustain period of one sub-field are grouped into a plurality of discharge groups 100, 101 and 102, each having a predetermined number. In each of the discharge groups 100, 101 and 102, a difference (Ws) in an application time between the sustain pulses is the same every discharge groups 100, 101 and 102. A difference (W_{L}) in an application time between two sustain pulses between the discharge groups 100, 101 and 102 is set to be greater than the difference (W_{S}) in the application time between the sustain pulses.

In other words, assuming that one sustain pulse refers to once sustain discharge and a plurality of sustain discharges generated in the sustain period is divided into the three discharge groups 100, 101 and 102 as shown in FIG. 8a, the difference (T_{S}) in the discharge time point between the sustain discharges comprised in each of the discharge groups 100, 101 and 102 is set to be the same. The difference (T_{L}) in the discharge time point between two sustain discharges between the respective three discharge groups 100, 101 and 102 is set to be greater than the difference (T_{S}) in the discharge time point between the sustain discharges comprised in the respective discharge groups 100, 101 and 102. The number of the sustain discharges comprised in each of the discharge groups 100, 101 and 102, i.e., the number of the sustain pulses can be set to be different or the same, as shown in FIG. 8a.

The sum of the difference (T_{L}) between the discharge time points between the respective discharge groups 100, 101 and 102 can be set in the range of 10 μs to 500 μs.

The reason why the sum of the difference (T_{L}) between the discharge time points between the respective discharge groups 100, 101 and 102 can be set in the range of 10 μs to 500 μs, as described above, is to secure sustain margin when the plasma display panel is driven while reducing the luminance saturation characteristic of the phosphors as described above in the first embodiment of the present invention.

Furthermore, the sum of the difference (T_{L}) between the discharge time points between the respective discharge groups 100, 101 and 102 can be controlled according to the luminance saturation characteristic of the phosphors. The sum of the difference (T_{L}) between the discharge time points between the respective discharge groups 100, 101 and 102 can be set to increase within the range of 10 μs to 500 μs as the luminance saturation characteristic of the phosphors becomes profound.

A driving method in which the plasma display apparatus is driven with sustain pulses applied in the sustain period being divided into two groups can be employed in order to secure sustain margin more effectively. This method will be described with reference to FIG. 8b.

Referring to FIG. 8b, sustain pulses comprised in a sustain period of one sub-field are grouped into two groups 103, 104. A difference (W_{S}) in an application time between the sustain pulses comprised in the respective groups 103, 104 is set to be the same. Furthermore, A difference (W_{L}) between application times of two sustain pulses between the respective groups 103, 104 is set to be greater than a difference (W_{S}) between application times of other sustain pulses.

In other words, assuming that one sustain pulse refers to once sustain discharge and a plurality of sustain discharges generated in a sustain period is divided into the two discharge groups 103, 104 as described above, the difference (T_{S}) in the discharge time point between the sustain discharges comprised in each of the discharge groups 103, 104 is set to be the same. The difference (T_{L}) in the discharge time point between the two discharge groups 103, 104 is set to be greater than the difference (T_{S}) in the discharge time point between the sustain discharges comprised in the respective discharge groups 103, 104.

In this case, the number of the sustain pulses comprised in each of the groups 103, 104 can be controlled depending on a luminance characteristic of phosphors. For example, assuming that a total number of sustain discharges comprised in the two discharge groups 103, 104 is N, the discharge groups of any one of the two discharge groups 103, 104 has the number of discharges in the range of 2 to (N−2). The number of sustain discharges comprised in the two discharge groups 103, 104 can be the same.

A difference between the discharge time points of the two sustain discharge between the two discharge groups 103, 104, i.e., the difference (T_{L}) in the discharge time point between the two discharge groups 103, 104 can be set to range from 10 μs to 500 μs. The reason can be described as follows. As described above, since the length of a sustain period of one sub-field could not be long infinitely, a time of 500 μs at most is set to the difference (T_{L}) in the discharge time point of two sustain discharges between the two discharge groups 103, 104. Furthermore, only when a time of 10 μs or higher is set to the difference (T_{L}) between the discharge time points of two sustain discharges between the two discharge groups 103, 104, luminance can be prevented from being degraded due to a luminance saturation characteristic of phosphors and driving efficiency can be improved accordingly.

The difference (T_{L}) in the discharge time point between the two discharge groups 103, 104 can be set to range from 10 μs to 500 μs.

Meanwhile, a difference in the discharge time point between sustain discharges comprised in one of the two discharge groups 103, 104, e.g., the discharge group 103, and a difference in the discharge time point between sustain discharges comprised in the other of the two discharge groups 103, 104, e.g., the discharge group 104 can be set to be the same. It is, however, to be understood that a difference in the discharge time point between sustain discharges comprised in one of the two discharge groups 103, 104 and a difference in the discharge time point between sustain discharges comprised in the other of the two discharge groups 103, 104 can be set to be different from each other.

In this case, the time lag (T_{L}) in the discharge time point between the discharge groups can be controlled according to a luminance saturation characteristic of phosphors. The time lag (T_{L}) in the discharge time point between the discharge groups can be set to increase as a luminance saturation characteristic of phosphors becomes profound.

In FIG. 8b, it has been described that the number of the sustain discharges comprised in each of the discharge groups 103, 104, i.e., the number of the sustain pulses is set to be the same in each of the groups 103, 104. Unlike the above, the number of sustain discharges comprised in one of the groups 103, 104, i.e., the number of sustain pulses can be set to be many or small.

As shown in FIG. 8c, unlike FIG. 8b, the number of sustain discharges comprised in a first discharge group 105 is set to be smaller than those comprised in a second discharge group 106. For example, only one sustain discharge, i.e., only one sustain pulse or only a pair of sustain discharges, i.e., only a pair of sustain pulses can be comprised in the first discharge groups 105, and the remaining sustain discharge, i.e., the sustain pulses can be comprised in the second discharge groups 106.

Alternately, as shown in FIG. 8d, the number of sustain discharges comprised in a discharge group A 108 is set to be smaller than those comprised in a discharge group B 107. For example, only one sustain discharge, i.e., only one sustain pulse or only a pair of sustain discharges, i.e., only a pair of sustain pulses can be comprised in the discharge group A 108, and the remaining sustain discharges, i.e., sustain pulses can be comprised in the discharge group B 107.

By driving sustain discharges in one sustain period with them being divided into groups as described above, a decrease in driving efficiency of a plasma display panel, which is incurred by the luminance saturation characteristic of phosphors, can be prohibited.

The second embodiment of the present invention is substantially the same as the first embodiment. Description thereof will be omitted in order to avoid redundancy.

In the first embodiment or the second embodiment of the present invention, it has been described that a difference in a discharge time between sustain discharges in a sustain period is controlled only in one sub-field. Unlike the above, a predetermined sub-field is selected within one frame, and a difference in a discharge time between sustain discharges in a sustain period can be controlled only in the selected sub-field. A driving waveform in this case will be described in connection with the following third embodiment.

FISG. 9a and 9b are views for illustrating a driving method of a plasma display apparatus according to a third embodiment of the present invention.

As shown in FIGS. 9a and 9b, in the driving method of the plasma display apparatus according to the third embodiment of the present invention, a plurality of sustain pulses applied to the scan electrodes Y or the sustain electrodes Z in a sustain period in at least one of a plurality of sub-fields is divided into a plurality of sustain pulse groups. A time lag between at least one sustain pulse group, of times lags between the plurality of sustain pulse groups, is set to be different from that between the remaining sustain pulse groups.

The time lag between the plurality of sustain pulse groups can be set to be greater than that between sustain pulses within sustain pulse groups.

Referring to FIG. 9a, in the third embodiment of the present invention, unlike the first embodiment or the second embodiment of the present invention, a predetermined number of sub-fields (E, F) is selected from sub-fields forming one frame, and a time lag between sustain pulses comprised in a plurality of sustain pulse groups is set to be different from that between the respective sustain pulse groups only in a sustain period of the selected sub-fields (E, F).

The time lag between the sustain pulse groups and the time lag between the sustain pulses can be expressed in a time lag between sustain discharge groups and a time lag between sustain discharges. A sub-field in which a difference in the discharge time point between sustain discharges comprised in a plurality of discharge groups is set to be different from a difference in the discharge time point between the respective discharge groups, in the sustain period, can be selected depending on the number of the sustain discharges in the sustain period, i.e., the number of the sustain pulses. For example, a difference in the discharge time point between sustain discharges comprised in a plurality of discharge groups and a difference in the discharge time point between the respective discharge groups, in a sustain period in the entire sub-fields of one frame, can be set to be different from each other.

Alternately, a difference in the discharge time point between sustain discharges comprised in a plurality of discharge groups, and a difference in the discharge time point between the respective discharge groups, in a sustain period of sub-fields from the last sub-field of a plurality of sub-fields to a predetermined sub-field, can be set to be different from each other. An example of a method of selecting sub-fields from the last sub-field to a predetermined sub-field is shown in FIG. 9b.

Referring to FIG. 9b, a difference in the discharge time point between sustain discharges comprised in a plurality of discharge groups and a difference in the discharge time point between the respective discharge groups are set to be different from each other only in a sustain period of the last sub-field of a plurality of sub-fields.

In FIG. 9b, it has been described that a difference in the discharge time point between the sustain discharges comprised in the plurality of discharge groups and a difference in the discharge time point between the respective discharge groups are set to be different from each other only in the sustain period of the last sub-field. However, a difference in the discharge time point between sustain discharges comprised in a plurality of discharge groups and a difference in the discharge time point between the respective discharge groups can be set to be different from each other in a sustain period of sub-fields from the last sub-field to the second sub-field or from the last sub-field to the third sub-field.

In this case, the reason why a difference in the discharge time point between the sustain discharges comprised in the plurality of discharge groups and a difference in the discharge time point between the respective discharge groups are set to be different from each other in the sustain period from a last sub-field to a predetermined sub-field, of the sub-fields comprised in one frame, is that a possibility that driving efficiency may be degraded becomes high because phosphors are saturated in sub-fields on the rear side where the number of sustain discharges, i.e., the number of sustain pulses is relatively many.

The third embodiment of the present invention is substantially the same as the first embodiment or the second embodiment. Description thereof will be omitted in order to avoid redundancy.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A plasma display apparatus, comprising:
a plasma display panel comprising scan electrodes and sustain electrodes;
a driver that applies a plurality of sustain pulses to the scan electrodes or the sustain electrodes; and
a timing controller that controls a time lag from at least one of the plurality of sustain pulses to a next sustain pulse to be different from a time lag from the remaining sustain pulses to a next sustain pulse.

2. The plasma display apparatus as claimed in claim 1, wherein the timing controller controls a time lag from at least one of the plurality of sustain pulses to a next sustain pulse to be longer than a time lag from the remaining sustain pulses to a next sustain pulse.

3. The plasma display apparatus as claimed in claim 2, wherein a time lag from at least one of the plurality of sustain pulses to a next sustain pulse is set in the range of 10 μs to 500 μs.

4. The plasma display apparatus as claimed in claim 1, wherein a time lag from at least one of the plurality of sustain pulses to a next sustain pulse is controlled according to a luminance saturation characteristic of phosphors.

5. The plasma display apparatus as claimed in claim 4, wherein a time lag from at least one of the plurality of sustain pulses to a next sustain pulse is set to increase as the luminance saturation characteristic of the phosphors becomes profound.

6. A plasma display apparatus that displays images through a combination of a plurality of sub-fields, comprising:
a plasma display panel in which a plurality of sustain pulses is applied in a sustain period of the sub-fields; and
a timing controller that controls the plurality of sustain pulses to be divided into a plurality of sustain pulse groups, and controls a time lag between the sustain pulse groups to be different from that between sustain pulses within the sustain pulse groups, in at least one of the plurality of sub-fields.

7. The plasma display apparatus as claimed in claim 6, wherein the timing controller controls the time lag between the sustain pulse groups to be longer than that between the sustain pulses within the sustain pulse groups.

8. The plasma display apparatus as claimed in claim 7, wherein the time lag between the sustain pulses within the sustain pulse groups is set to be the same.

9. The plasma display apparatus as claimed in claim 7, wherein the time lag between the sustain pulse groups is set to range from 10 μs to 500 μs.

10. The plasma display apparatus as claimed in claim 6, wherein the number of the sustain pulse groups is 2.

11. The plasma display apparatus as claimed in claim 6, wherein the time lag between the sustain pulse groups is controlled according to a luminance saturation characteristic of phosphors.

12. The plasma display apparatus as claimed in claim 11, wherein the time lag between the sustain pulse groups is set to increase as the luminance saturation characteristic of the phosphors becomes profound.

13. The plasma display apparatus as claimed in claim 6, wherein the number of the sustain pulses within each of the plurality of sustain pulse groups is the same.

14. A driving method of a plasma display apparatus that displays images through a combination of a plurality of sub-fields,
wherein a plurality of sustain pulses applied in a sustain period of the sub-fields is divided into a plurality of sustain pulse groups, and
a time lag between the sustain pulse groups is set to be different from that between sustain pulses within the sustain pulse groups in at least one of the plurality of sub-fields.

15. The driving method as claimed in claim 14, wherein the time lag between the sustain pulse groups is set to be longer than that between the sustain pulses within the sustain pulse groups.

16. The driving method as claimed in claim 15, wherein the time lag between the sustain pulses within the sustain pulse groups is set to be the same.

17. The driving method as claimed in claim 15, wherein the time lag between the sustain pulse groups is set to range from 10 μs to 500 μs.

18. The driving method as claimed in claim 14, wherein the number of the sustain pulse groups is 2.

19. The driving method as claimed in claim 14, wherein the time lag between the sustain pulse groups is controlled according to a luminance saturation characteristic of phosphors.

20. The driving method as claimed in claim 14, wherein the number of the sustain pulses within each of the plurality of sustain pulse groups is the same.
